(19) United States
(12) Patent Application Publication
(10) Pub. No.: US 2010/0004943 A1
(43) Pub. Date: Jan. 7, 2010

(54) Newspaper on a container

(76) Inventor: Emmanuel Kpabitey, Bronx, NY (US)

Correspondence Address: STEVEN HOROWITZ, ESQ., 295 MADISON AVE, SUITE 700, NEW YORK, NY, 10017, US

(21) Appl. No.: 12/217,610

(22) Filed: Jul. 2, 2008

(51) Int. Cl. G06Q 30/00

(52) U.S. Cl. 705/1; 705/14.58

(57) ABSTRACT

A method of enhancing sales of a product sold in a bottle comprises placing a newspaper containing an issue date on a label and placing the label on a bottle. Subsequent issues of the newspaper are placed on subsequent series of copies of the label and bottle. The news summaries or newspaper is associated with a news cycle having a time period and the subsequent issues follow immediately after the earlier news cycles, just like an ordinary newspaper. Each issue of the newspaper is published by sending the bottle into the stream of commerce at or near the beginning of the news cycle to which the bottle/label pertains. The news summaries are readable by a consumer of the product even as the bottle is on the shelf or may be detachable from the label.

### BACKGROUND OF THE INVENTION

The present invention generally relates to apparatus and methods for delivering newspapers and, more particularly, to apparatus and methods of incorporating a newspaper into the label of a container for a product.

There are numerous ways that have been invented to increase sales of a product. For example, it is known to tie sales of a first product to a second product in order to increase sales of the first product. This may involve offering a gift upon purchase of a particular product. Another technique that has been used to increase sales of a first product may be to increase the number of people who are exposed to the product through advertising. The advertising may be as a simple as enticing customers to enter a store in which the first product is offered by means of attractive window displays of a well known product or it may involve other techniques. It is also well known to offer volume discounts for a product, and these can be presented in many different forms. As can be seen, there is a need to find novel ways to increase sales of a product.

Products may be advertised in many ways to increase the number of potential buyers who are exposed to the product. Advertisers are always looking for new contexts in which to advertise products. For example, moving vehicles such as taxis have been outfitted with advertisements. There is a need to find new media or new contexts in which to advertisements may be placed.

### SUMMARY OF THE PRESENT INVENTION

In one aspect of the present invention, there is presented a method of enhancing sales of a product sold in a bottle, comprising placing a date portion on a label, the date portion including a time period that corresponds to a news cycle; obtaining news summaries whose target audience is calculated without regard to consumers of the product nor purchasers of other products sold by dealers in the product; placing the news summaries on the label, the news summaries providing news of the news cycle; and permanently affixing the label to an outer surface of the bottle in a manner that allows the news summaries to be viewable and readable by a consumer of the product.

In a further aspect of the invention, there is presented a method of enhancing sales of a product sold in a bottle, comprising placing a first date portion on a first label, the first date portion including a first time period that corresponds to a first news cycle; obtaining news summaries whose target audience is calculated without regard to consumers of the product nor purchasers of other products sold by dealers in the product; placing the news summaries on the first label, the news summaries providing news of the first news cycle; permanently affixing the first label to an outer surface of a first bottle in a manner that allows the news summaries to be viewable and readable by a consumer of the product; repeating the above steps for a series of first labels on a series of first bottles; placing a second date portion on a second label, the second date portion including a second time period that corresponds to a second news cycle, the second time period following immediately after the first time period; obtaining news summaries whose target audience is calculated without regard to consumers of the product nor purchasers of other products sold by dealers in the product; placing the news summaries on the second label, the news summaries providing news of the second news cycle; permanently affixing the second label to outer surfaces of a series of second bottles in a manner that allows the news summaries to be viewable and readable by a consumer of the product; and repeating the above steps that pertain to the second label for a series of second labels on a series of second bottles.

In another aspect of the invention, there is presented a bottle designed to enhance sales of a product sold in the bottle, comprising a container for holding the product, a single page newspaper wrapped around the container in the form of a label, the newspaper numbered by issue, the issue corresponding to a news cycle forming a part of a series of consecutive news cycles associated with consecutive time periods and associated with a series of bottles.

In a further aspect of the present invention, there is presented a method of selling a product, comprising obtaining copies of a first issue of a newspaper, the newspaper having a target audience that is calculated without regard to consumers of the product nor purchasers of other products sold by dealers in the product; affixing the copies of the first issue to a series of first containers that hold the product, one copy of the first issue to one first container; obtaining copies of a second and subsequent issues of the newspaper; affixing the copies of the second and subsequent issues to a series of second and subsequent containers that hold the product; and placing the series of first, second and subsequent containers into a stream of commerce timed for a publication of the first, second and subsequent issues of the newspaper.

In a still further aspect of the present invention, there is presented a method of enhancing sales of a product sold in a container, comprising adhering a series of copies of a first issue of a newspaper around a series of first bottles, one copy to a bottle, the newspaper having a target audience calculated without regard to consumers of the product or purchasers of other products sold by dealers in the product, the newspaper having a first date and being readable by a consumer of the product; sending the first bottle into a stream of commerce; adhering a series of copies of a second issue of the newspaper around a series of second bottles, one copy to a bottle, the newspaper having a second date and being readable by a consumer of the product; and sending the second bottle into the stream of commerce.

In a further aspect of the present invention, there presented a method of selling a product, comprising obtaining first, second and subsequent bottles that contain the product; calculating a segment of the public targeted by a newspaper without regard to the product; affixing copies of a first issue of the newspaper to labels on the first bottles, one copy to a first bottle; affixing copies of a second and subsequent issue of the newspaper to labels on the second and subsequent bottles, one copy to a second and subsequent bottle; placing the first, second and subsequent bottles into a stream of commerce timed to publication of the first, second and subsequent issues of the newspaper.

These and other features, aspects and advantages of the present invention will become better understood with reference to the following drawings, descriptions and claims.

### BRIEF DESCRIPTION OF THE DRAWINGS

FIG. 1 is a flow chart showing a method of the present invention;

FIG. 2 is a flow chart showing a method of the present invention;

FIG. 3 is a flow chart showing a method of the present invention;

FIG. 4 is a flow chart showing a method of the present invention;

FIG. 5 is a flow chart showing a method of the present invention;

FIG. 6A is a perspective view of a bottle in accordance with the present invention;

FIG. 6B is a sectional view of the bottle of FIG. 6A along line 6B-6B; and

FIG. 6C is a perspective view of an alternatively shaped bottle in accordance with the method and apparatus of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention generally provides a method of selling products contained in a bottle, for example, a bottle of soft drink, by placing a newspaper on the bottle incorporated into the label. The newspaper may be a one page newspaper that may contain news summaries concerning a news cycle whose date or time period may also be on the same label. The newspaper may be entirely unrelated to the product or the company selling the product. Each subsequent issue of the newspaper may follow consecutively in time periods whose dates may be stated on the label. As consumers take an interest in the newspaper, which may only be available on the bottle or container, they may come to feel that they have an additional reason to purchase the product—to read the latest issue of the newspaper.

In contrast to the prior art, in which products are sold with a label that may be targeted to consumers of the product or to purchasers of other products sold by dealers in the product, the method and apparatus of the present invention may make use of a label containing a newspaper, or a newspaper on or affixed to a label, in which the newspaper may be targeted to a segment of the general public, such as consumers within a certain demographic group, and the target audience is calculated without regard to consumers of the product sold in the bottle or purchasers of other products sold by dealers in the product. Hence the news in the newspaper may cover issues of interest to that demographic group. In further contrast to the prior art, in which techniques for increasing sales of a product may involve traditional methods such as volume discounts, deals or special discounts on other products, the method and apparatus of the present invention involves increasing the sale of the product by attaching an interesting newspaper to the product and may include making the issues of the newspaper available only on the product.

A “dealer” as used herein may include the seller of the product, the manufacturer of the product, a marketer of the product, a middleman, a distributor of the product, a wholesaler of the product, a retailer of the product. The “dealer” may include anyone in the stream of commerce relating to the product in question and anyone who provides marketing or other services to those in the stream of commerce for the sale of the product at any state of its distribution.

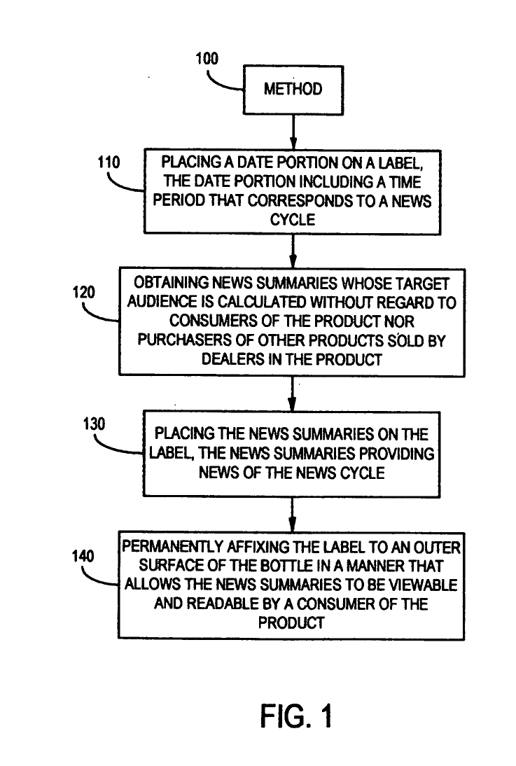

As seen from FIG. 1, the present invention can be viewed as a method 100 of enhancing sales of a product sold in a bottle or other container. A step 110 of method 100 may involve placing a first date portion on a first label. The first date portion may include a first time period that may correspond to a first news cycle. For example, the first date portion may be a particular day, week, month, quarter, half-year or year or any other time interval that may be associated with a newspaper issue. The first news cycle and date portion may correspond to these time intervals. For example, the news summaries may provide news of the first news cycle (i.e. news for that week).

A further step 120 of method 100 may involve preparing, creating or obtaining news summaries, or copies of an issue of a newspaper, whose target audience is calculated like any newspaper, i.e. without regard to dealers in the product (container in the bottle), consumers of the product (contained in the bottle) or consumers of other products sold by dealers in this product (contained in the bottle). For example, the news summaries may be topical or targeting a particular demographic group. Alternatively, the news summaries may be similar to blurbs in the Wall Street Journal covering domestic and international events. The news summaries, and the newspaper issue, may be a single page. Alternatively, the news summaries or newspaper issue may be comprised of multiple pages connected in a manner (for example, at a top edge wherein each page may be separated off) that only one of the pages is affixed to an outer surface of the bottle as a label. The news summaries may be blurbs concerning general topics of interest to the public or to a segment of the public. In addition, the news summaries or newspaper issue may be available only on the bottle or other container. That is, circulation of the newspaper containing the news summaries may be restricted to consumers of the product, thereby exploiting interest in the news summaries as a means of increasing sales of the product. The newspaper may be owned by an entity that is different from the seller, manufacturer and/or dealer in the product.

In a further step 130 of method 100, the news summaries or an issue of the newspaper may be placed on the first label. The news summaries or newspaper may be configured so that the newspaper or news summaries may be readable while the bottle is stationed on the shelf of a supermarket or other store in an upright position. A further step may include placing advertisements on the label. The advertisements may be from entities other than a seller or dealer in the product and may be directed to the consumers of the product in the bottle.

In certain embodiments, the news summaries and/or issue of the newspaper may be separately detachable from the label to make them easier to read. In this case, the remainder of the label may function as an ordinary label once the newspaper or news summary portion had been removed from the label.

In a further step 140 of method 100, the first label may be permanently affixed to an outer surface of a first bottle in a manner that allows the news summaries to be viewable and readable by a consumer of the product. “Permanently affixing” the label does not necessarily mean that the label can never be removed. It merely means that the label may be affixed sufficiently permanently that the label may remain affixed to the bottle as the bottle moves through the stream of commerce. The bottle or other container with the label on it may then be sold or otherwise placed into the stream of commerce. The bottle may be placed into the stream of commerce at or near a beginning of the news cycle to which the issue of the news paper (or the news summaries) correspond.

Since thousands of bottles may be sold, the above steps may be repeated for a series of first labels on a series of first bottles. Each of the thousands of bottles sold for this news cycle is called a “first bottle” since it corresponds to the first news cycle which is associated with a first time period and a first date or date portion on the label.

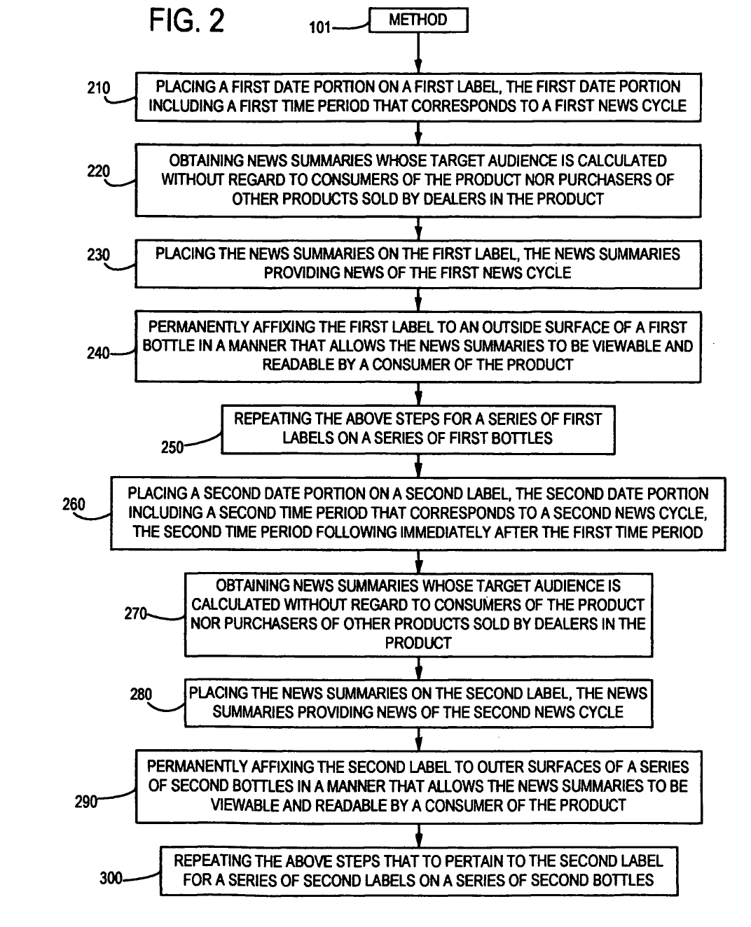

As seen from FIG. 2, the present invention may be viewed as a method 101 of enhancing sales of a product sold in a bottle, which can be considered an expanded version of method 100. Method 101 may include step 210 of placing a first date portion on a first label, the first date portion including a first time period that corresponds to a first news cycle, step 220 of obtaining news summaries whose target audience is calculated without regard to consumers of the product nor purchasers of other products sold by dealers in the product, step 230 of placing the news summaries on the first label, the news summaries providing news of the first news cycle, step 240 of permanently affixing the first label to an outer surface of a first bottle in a manner that allows the news summaries to be viewable and readable by a consumer of the product and step 250 of repeating the above steps for a series of first labels on a series of first bottles.

Method 101 expands upon method 100 and may include steps 260 of placing a second date portion on a second label, the second date portion including a second time period that corresponds to a second news cycle, the second time period following immediately after the first time period, step 270 of obtaining news summaries whose target audience is calculated without regard to consumers of the product nor purchasers of other products sold by dealers in the product, step 280 of placing the news summaries on the second label, the news summaries providing news of the second news cycle, step 290 of permanently affixing the second label to outer surfaces of a series of second bottles in a manner that allows the news summaries to be viewable and readable by a consumer of the product, and step 300 of repeating the above steps 260-290 that pertain to the second label for a series of second labels on a series of second bottles.

This may be repeated for a third news cycle, a fourth and subsequent news cycles as often as necessary. For example, the first issue of a newspaper may correspond to the first week of 2008 which is a first news cycle. The second issue of the newspaper may have a second date or date portion on the label that corresponds to a second news cycle—the second week of 2008. This may be continued ad infinitum for as many newspaper issues and news cycles as desired. It is noted that the second news cycle may continue on the heels of the first news cycle and the third news cycle may continue immediately after the end of the second news cycle. Likewise, the second date period may continue on the heels of the first date period and the third date period may commence immediately after the end of the second date period and the third date period may continue right after the end of the second date period, and so on.

A series of copies of the first bottle or container may contain a first label with a first issue of the newspaper or news summaries corresponding to the first news cycles. Furthermore, second, third, fourth and subsequent series of copies of a second bottle or container may contain a second and subsequent label with a second, third, fourth and subsequent issues of the newspaper or news summaries and correspond to the second, third, fourth and subsequent news cycles and time periods. Each of these bottles may be placed into the stream of commerce timed to correspond with the corresponding news cycle associated with the issue, i.e. at or near the beginning of the corresponding news cycle.

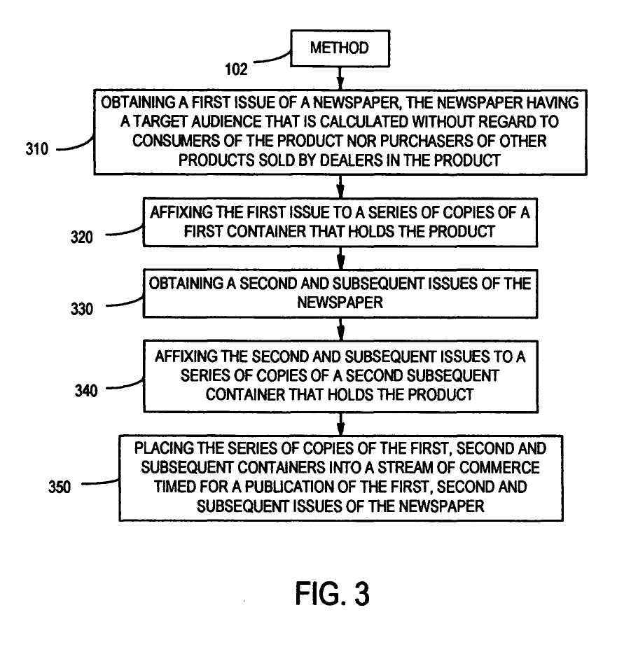

As seen from FIG. 3, the present invention may also be described as a method 102 of selling a product. A step 310 in method 102 may involve obtaining copies of a first issue of a newspaper, the newspaper having a target audience that is calculated without regard to consumers of the product and without regard to purchasers of other products sold by dealers in the product. A further step 320 of method 102 may entail affixing the copies of the first issue to a series of first containers that hold the product, one copy of the first issue per first container. Furthermore, method 102 may also include a step 330 of obtaining copies of a second and subsequent issues of the newspaper and a step 340 of affixing the copies of the second and subsequent issues to a series of second and subsequent containers that hold the product, one copy of the second and subsequent issues per second and subsequent container. Method 102 may also include a step 350 of placing the series of first, second and subsequent containers into a stream of commerce timed for a publication of the first, second and subsequent issues of the newspaper.

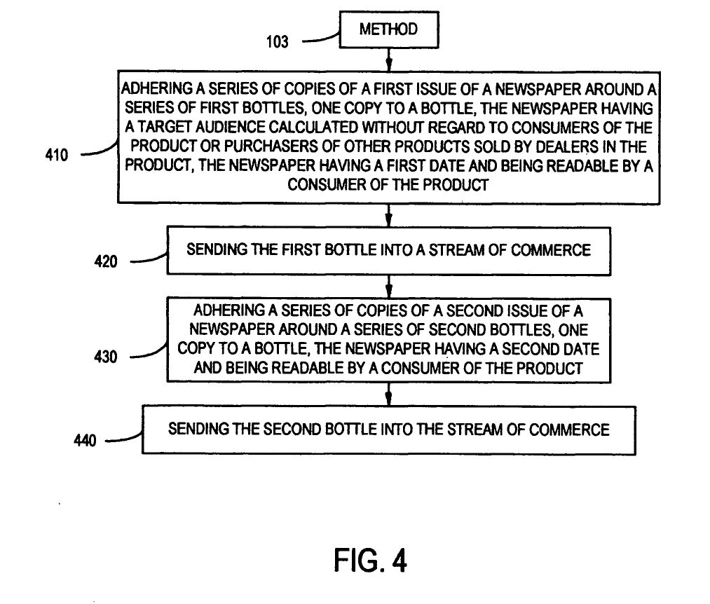

As seen from FIG. 4, the present invention may also be characterized as a method 103 of enhancing sales of a product sold in a container. Method 103 may include a step 410 of adhering a series of copies of a first issue of a newspaper around a series of first bottles, one copy to a bottle, the newspaper having a target audience calculated without regard to consumers of the product or purchasers of other products sold by dealers in the product, the newspaper having a first date and being readable by a consumer of the product. A further step 420 may involve sending the first bottle into a stream of commerce. A still further step 430 may include adhering a series of copies of a second issue of the newspaper around a series of second bottles, one copy to a bottle, the newspaper having a second date and being readable by a consumer of the product. Method 103 may also involve a step 440 of sending the second bottle into the stream of commerce.

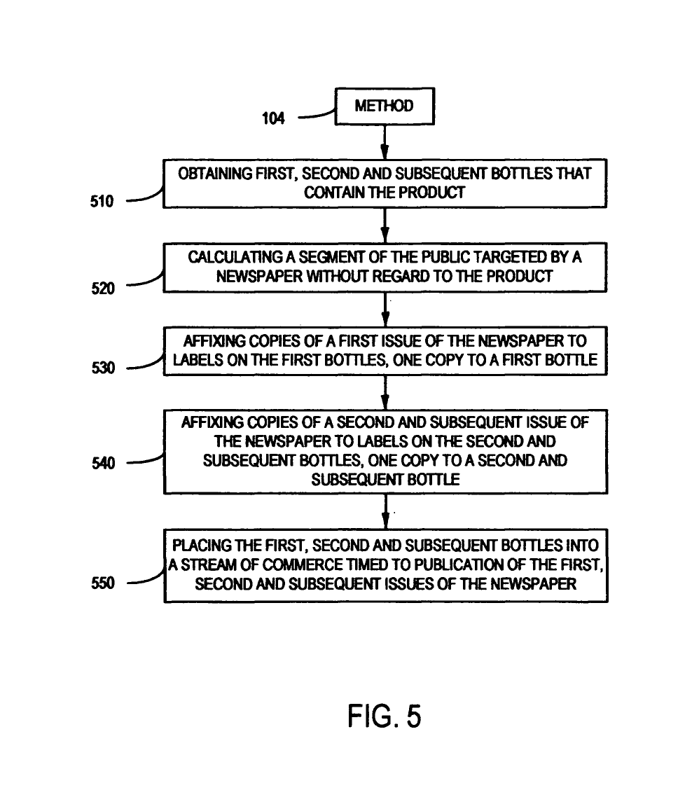

As seen from FIG. 5, the present invention may also generally be characterized as a method 104 of selling a product, comprising a step 510 of obtaining first, second and subsequent bottles that contain the product. An additional step 520 of method 104 may involve calculating a segment of the public targeted by a newspaper without regard to the product (i.e. without regard to the product or to other products sold by dealers in this product). A further step 530 may involve affixing copies of a first issue of the newspaper to labels on the first bottles, one copy to a first bottle and a further step 540 of affixing copies of a second and subsequent issue of the newspaper to labels on the second and subsequent bottles, one copy to a second and subsequent bottle. The method 104 may also entail a step 550 of placing the first, second and subsequent bottles into a stream of commerce timed to publication of the first, second and subsequent issues of the newspaper.

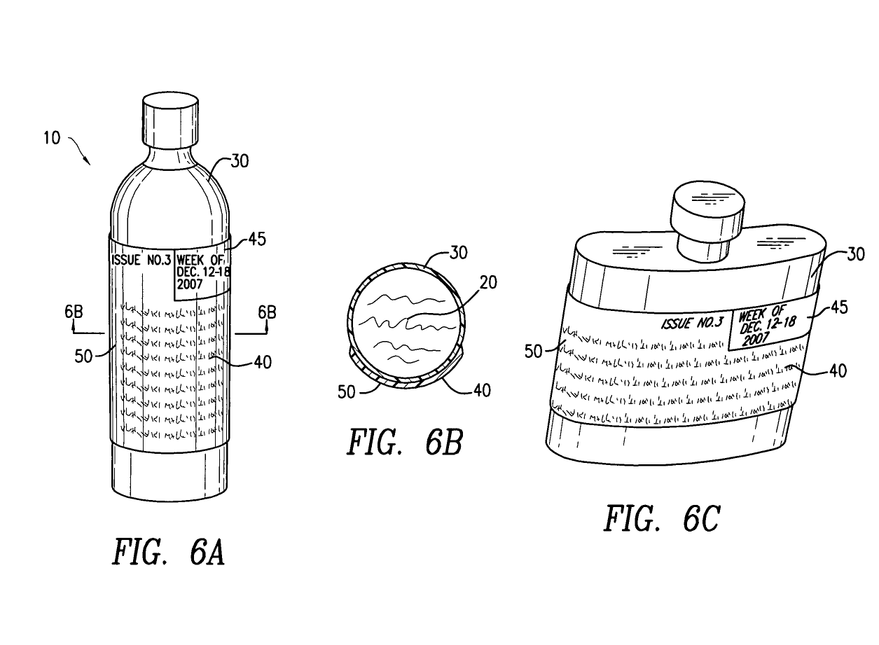

As seen from FIGS. 6A and 6B, the present invention may also be characterized as a bottle 10 designed to enhance sales of a product 20 sold in the bottle 10. Bottle 10 may include a container 30 for holding product 20 and a newspaper 40 may be affixed to or may be wrapped around the container 30 in the form of a label 50. Newspaper 40 may be a single page. Label 50 or newspaper 40 may include a date portion 45. Newspaper 40 have also have a name of the newspaper stated thereon.

Newspaper 40 may also be numbered by issue, for example issue no. 1, no. 2, etc. Each issue of newspaper 40 may corresponds to a news cycle and an interval or period of time (i.e. a first week of a year) associated with date portion 45. The news cycles and date portions may be consecutive. For example issue no. 1 may correspond to the first week of the year and issue no. 2 may correspond to the second week of the year, etc. Thus the news cycles form part of a series of consecutive news cycles associated with consecutive time periods. The news cycles are also associated with a series of bottles, for example a first bottle, second bottle, etc. wherein each distinct bottle contains a different issue of the newspaper.

Although FIG. 6A and FIG. 6B show bottle 10 as round in cross-section, the cross-section of bottle 10 as used in the method and/or apparatus of the present invention may have other shapes as well. Purely by way of example, and as seen from FIG. 6C, bottle 10 may be shaped like the liquor bottles that are easy to hold in one hand, i.e. having two relatively flat, longer sides and having two much shorter and more rounded sides. Having two relatively longer sides may make reading the newspaper 40 while newspaper is attached to bottle 10 somewhat easier.

It should be understood, of course, that the foregoing relates to exemplary embodiments of the invention and that modifications may be made without departing from the spirit and scope of the invention as set forth in the following claims.

We claim:

1. A method of enhancing sales of a product sold in a bottle, comprising:
placing a date portion on a label, the date portion including a time period that corresponds to a news cycle;
obtaining news summaries whose target audience is calculated without regard to consumers of the product nor purchasers of other products sold by dealers in the product;
placing the news summaries on the label, the news summaries providing news of the news cycle; and
permanently affixing the label to an outer surface of the bottle in a manner that allows the news summaries to be viewable and readable by a consumer of the product.

2. The method of claim 1, further comprising restricting availability of the news summaries to consumers of the product.

3. The method of claim 1, further comprising placing on the label an advertisement by an entity other than a dealer in the product, the advertisement directed to consumers of the product.

4. The method of claim 1, further comprising detaching the news summaries from the label so that they can be more easily read, whereby after such detachment a remainder of the label remains on the label, the remainder being suitable for use as a label of the product on the bottle.

5. The method of claim 4, further comprising positioning the news summaries so that they are readable while the bottle is standing up.

6. The method of claim 1, further comprising placing the bottle into a stream of commerce.

7. A method of enhancing sales of a product sold in a bottle, comprising:
placing a first date portion on a first label, the first date portion including a first time period that corresponds to a first news cycle;
obtaining news summaries whose target audience is calculated without regard to consumers of the product nor purchasers of other products sold by dealers in the product;
placing the news summaries on the first label, the news summaries providing news of the first news cycle;
permanently affixing the first label to an outer surface of a first bottle in a manner that allows the news summaries to be viewable and readable by a consumer of the product;
repeating the above steps for a series of first labels on a series of first bottles;
placing a second date portion on a second label, the second date portion including a second time period that corresponds to a second news cycle, the second time period following immediately after the first time period;
obtaining news summaries whose target audience is calculated without regard to consumers of the product nor purchasers of other products sold by dealers in the product;
placing the news summaries on the second label, the news summaries providing news of the second news cycle;
permanently affixing the second label to outer surfaces of a series of second bottles in a manner that allows the news summaries to be viewable and readable by a consumer of the product; and
repeating the above steps that pertain to the second label for a series of second labels on a series of second bottles.

8. The method of claim 7, further comprising placing a third date portion on a third label, the third date portion including a third time period that corresponds to a third news cycle, the third time period following immediately after the second time period;
obtaining news summaries whose target audience is calculated without regard to consumers of the product nor purchasers of other products sold by dealers in the product;
placing the news summaries on the third label, the news summaries providing news of the third news cycle;
permanently affixing the third label to outer surfaces of a series of third bottles in a manner that allows the news summaries to be viewable and readable by a consumer of the product; and
repeating the above steps that pertain to the third label for a series of third labels on a series of third bottles.

9. The method of claim 7, further comprising placing the first bottle into a stream of commerce at or near a beginning of the first news cycle and placing the second bottle into the stream of commerce at or near a beginning of the second news cycle.

10. The method of claim 7, further comprising placing the third bottle into a stream of commerce at or near a beginning of the third news cycle.

11. The method of claim 8, further comprising:
placing fourth and subsequent date portions on fourth and subsequent labels, the fourth and subsequent date portions including fourth and subsequent time periods that correspond to fourth and subsequent news cycle, the fourth and subsequent time periods following immediately one after another;
obtaining news summaries whose target audience is calculated without regard to consumers of the product nor purchasers of other products sold by dealers in the product;
placing the news summaries on the fourth and subsequent labels, the news summaries providing news of the fourth and subsequent news cycles; and
permanently affixing the fourth and subsequent labels to an outer surface of a fourth and subsequent bottles in a manner that allows the news summaries to be viewable and readable by a consumer of the product; and repeating the above steps that pertain to the fourth and subsequent labels for a series of fourth and subsequent labels on a series of fourth and subsequent bottles.

12. The method of claim 7, further comprising placing the first, second, third, fourth and subsequent bottles into a stream of commerce at or near a beginning of the first, second, third, fourth and subsequent news cycles.

13. A bottle designed to enhance sales of a product sold in the bottle, comprising:
a container for holding the product,
a single page newspaper wrapped around the container in the form of a label, the newspaper numbered by issue, the issue corresponding to a news cycle forming a part of a series of consecutive news cycles associated with consecutive time periods and associated with a series of bottles.

14. A method of selling a product, comprising:
obtaining copies of a first issue of a newspaper, the newspaper having a target audience that is calculated without regard to consumers of the product and without regard to purchasers of other products sold by dealers in the product;
affixing the copies of the first issue to a series of first containers that hold the product, one copy of the first issue per first container;
obtaining copies of a second and subsequent issues of the newspaper;
affixing the copies of the second and subsequent issues to a series of second and subsequent containers that hold the product, one copy of the second and subsequent issues per second and subsequent container; and
placing the series of first, second and subsequent containers into a stream of commerce timed for a publication of the first, second and subsequent issues of the newspaper.

15. The method of claim 14, wherein the container is a bottle.

16. The method of claim 15, wherein the affixing occurs by wrapping the issue of the newspaper around a body of the bottle so that the issue forms a label on the bottle.

17. A method of enhancing sales of a product sold in a container, comprising:
adhering a series of copies of a first issue of a newspaper around a series of first bottles, one copy to a bottle, the newspaper having a target audience calculated without regard to consumers of the product or purchasers of other products sold by dealers in the product, the newspaper having a first date and being readable by a consumer of the product;
sending the first bottle into a stream of commerce;
adhering a series of copies of a second issue of the newspaper around a series of second bottles, one copy to a bottle, the newspaper having a second date and being readable by a consumer of the product; and
sending the second bottle into the stream of commerce.

18. The method of claim 17, further comprising repeating the above steps for third and subsequent issues of the newspaper on a series of third and subsequent bottles.

19. The method of claim 17, wherein the first bottles have labels to which the first issue is removably attached and wherein the second bottles have labels to which the second issue is removably attached.

20. The method of claim 17, wherein the newspaper is one page.

21. A method of selling a product, comprising:
obtaining first, second and subsequent bottles that contain the product;
calculating a segment of the public targeted by a newspaper without regard to the product;
affixing copies of a first issue of the newspaper to labels on the first bottles, one copy to a first bottle;
affixing copies of a second and subsequent issue of the newspaper to labels on the second and subsequent bottles, one copy to a second and subsequent bottle; and
placing the first, second and subsequent bottles into a stream of commerce timed to publication of the first, second and subsequent issues of the newspaper.
